(19) United States
(12) Patent Application Publication
(10) Pub. No.: US 2026/0267210 A1
(43) Pub. Date: Sep. 10, 2026

(54) PROJECTING DEVICE AND ELECTRONIC DEVICE COMPRISING SAME

(71) Applicant: LG INNOTEK CO., LTD., Seoul (KR)

(72) Inventor: Sung Ha JANG, Seoul (KR)

(21) Appl. No.: 19/165,891

(22) PCT Filed: Mar. 15, 2024
(86) PCT No.: PCT/KR2024/003288

§ 371 Date: Sep. 16, 2025

(30) Foreign Application Priority Data
Mar. 17, 2023 (KR) 10-2023-0035324
Mar. 17, 2023 (KR) 10-2023-0035325
Mar. 15, 2024 (KR) 10-2024-0036334
Mar. 15, 2024 (KR) 10-2024-0036335

(51) Int. Cl. G03B 21/20; B82Y 20/00; G02B 1/00

(52) U.S. Cl. CPC G03B 21/208; B82Y 20/00; G02B 1/002; G03B 21/2066

(57) ABSTRACT

Disclosed, in one embodiment, is a projecting device comprising: alight source unit; alight modulator for modulating light emitting from the light source unit; a prism disposed between the light modulator and the light source unit; a reflection unit disposed between the light modulator and the prism; a first lens disposed between the prism and the light source unit; and a second lens disposed between the first lens and the prism, wherein the spacing between the first lens and the second lens is 0.8 to 1.2 times the thickness of at least one among the first lens and the second lens.

### TECHNICAL FIELD

Embodiments relate to a projecting device and an electronic device including the same.

### BACKGROUND ART

Virtual reality (VR) refers to a specific environment or situation or the technology itself, which is similar to reality but not real, generated by artificial technology using computers or the like.

Augmented reality (AR) is a technology that synthesizes virtual objects or information with the real environment to make the resultants look like objects existing in the original environment.

Mixed reality (MR) or hybrid reality refers to generating new environments or new information by combining the virtual world and the real world. Particularly, it is called mixed reality when it refers to the ability to interact in real time between things existing in reality and things existing in the virtual world.

In this case, the generated virtual environment, situation, or the like stimulates the users' five senses and allows them to freely move between reality and imagination by providing spatial and temporal experiences similar to reality. Additionally, the users can not only simply immerse themselves in these environments, but also interact with things implemented in these environments, such as by manipulating or giving commands using real devices.

Recently, research on apparatuses (gear, devices) used in these technical fields has been actively conducted. However, there is a growing need for miniaturization and improved optical performance of these apparatuses.

### DETAILED DESCRIPTION OF INVENTION

### Technical Problem

Embodiments provide a projecting device and an electronic device that are miniaturized and compactified through a lens at a rear end of a light source unit to be used as a projecting device and an electronic device including the same that are used for augmented reality (AR) or the like.

In addition, there may be provided a volume-reduced projecting device and electronic device by controlling the shape of at least one surface of a lens.

The problems to be solved by the embodiments are not limited thereto, and purposes or effects which may be grasped from solutions or embodiments of the problems to be described below are also included.

### Technical Solution

A projecting device according to an embodiment includes: a light source unit; an optical modulator configured to modulate light emitted from the light source unit; a prism disposed between the optical modulator and the light source unit; a reflector disposed between the optical modulator and the prism; a first lens disposed between the prism and the light source unit; and a second lens disposed between the first lens and the prism, wherein a distance between the first lens and the second lens is 0.8 to 1.2 times a thickness of at least one of the first lens and the second lens.

A ratio of a size of the optical modulator and a total volume of the light source unit, the first lens, and the second lens may range from 1:5 to 1:25 (inch:cc).

At least one of the first lens and the second lens may be a Fresnel lens.

The first lens and the second lens may be Fresnel lenses, each of the first lens and the second lens may include a plurality of lens regions, and a width of each of the plurality of lens regions may decrease in a direction away from a center of each of the first lens and the second lens.

Each of the lens regions may include a plurality of sub-regions, and a width of each of the sub-regions may become smaller in the direction away from the center of each of the first lens and the second lens.

A plurality of sub-regions may correspond to each other on each ofa light source unit-side surface and a reflector-side surface of the first lens.

Thicknesses of the first lens and the second lens may be the same.

A separation distance between the first lens and the second lens may be the same as a thickness of the first lens or the second lens.

Among the first lens and the second lens, a light source unit-side surface of the first lens may have the greatest radius of curvature.

In the second lens, a radius of curvature of a light source unit-side surface and a radius of curvature of a reflector-side surface may have different signs.

The projecting device may include a projection lens unit disposed at a rear end of the optical modulator.

Light emitted from the light source unit may be transmitted through the prism and light emitted from the optical modulator may be reflected by the prism.

A projecting device according to an embodiment includes: a light source unit; an optical modulator configured to modulate light emitted from the light source unit; a prism disposed between the optical modulator and the light source unit; a reflector disposed between the optical modulator and the prism; a first lens disposed between the prism and the light source unit; and a second lens disposed between the first lens and the prism, wherein at least one of the first lens and the second lens has a first metasurface.

The first metasurface may be located on at least one of a light source unit-side surface and a reflector-side surface of the first lens and the second lens.

The first metasurface may be arranged to form a shape distribution that changes a phase of incident light according to a predetermined rule depending on the position.

The first metasurface may include a plurality of patterned structures having a smaller width or thickness than a wavelength of incident light.

The plurality of structures may have a cylindrical shape, a polygonal columnar shape, or a stripe shape.

The projecting device may include a front prism disposed between the reflector and the light source unit.

The front prism may include an incident surface facing the light source unit and an exit surface through which light incident through the incident surface is emitted.

The front prism may include a second metasurface located on the incident surface.

A ratio of a size of the optical modulator and a total volume of the light source unit, the first lens, and the second lens may range from 1:5 to 1:25 (inch:cc).

The projecting device may include a projection lens unit disposed at a rear end of the optical modulator,

wherein light emitted from the light source unit may be transmitted through the prism and light emitted from the optical modulator may be reflected by the prism.

### Advantageous Effects

Embodiments implement a projecting device and an electronic device that are miniaturized and compactified through a lens at a rear end of a light source unit to be used as a projecting device and an electronic device including the same that are used for augmented reality (AR).

In addition, a volume-reduced projecting device and electronic device can be implemented by controlling the shape of at least one surface of a lens.

Various useful advantages and effects of the present invention are not limited to the above-described contents and can be more easily understood in a process of describing specific embodiments of the present invention.

### DESCRIPTION OF DRAWINGS

FIG. 1 is a block diagram showing the configuration of an extended reality electronic device according to an embodiment of the present invention.

FIG. 2 is a perspective view of an augmented reality electronic device according to the embodiment of the present invention.

FIG. 3 is a perspective view of a projecting device according to the embodiment.

FIG. 4 is another perspective view of the projecting device according to the embodiment.

FIG. 5 is an exploded perspective view of the projecting device according to the embodiment.

FIG. 6 is a cross-sectional view along line AA′ in FIG. 3.

FIGS. 7 and 8 are views of the projecting device according to the embodiment from which a housing is removed.

FIG. 9 is a cross-sectional view of a light source unit, a first lens, a second lens, a first mirror, a second mirror, and a third lens in the projecting device according to the embodiment.

FIG. 10 is a cross-sectional view of a light source unit, a first lens, a second lens, a first mirror, a second mirror, and a third lens in a projecting device according to a comparative example.

FIG. 11 is a perspective view of the first lens or the second lens in the projecting device according to the embodiment.

FIG. 12 is a cross-sectional view of the first lens or the second lens in the projecting device according to the embodiment.

FIG. 13 is another perspective view of the first lens or the second lens in the projecting device according to the embodiment.

FIGS. 14 and 15 are views showing the optical performance of the projecting devices according to the comparative example and the embodiment.

FIG. 16 is a configuration diagram of the light source unit side according to various examples in the projecting device according to the embodiment.

FIG. 17 is a cross-sectional view of a light source unit, a first lens, a second lens, a first mirror, a second mirror, and a third lens in a projecting device according to another embodiment.

FIG. 18 is a schematic view of a metasurface applied to a rear end of the light source unit according to the embodiment.

FIG. 19 is a schematic perspective view of a metasurface according to another embodiment.

FIG. 20 is a schematic perspective view of a metasurface according to still another embodiment.

FIG. 21 is a schematic perspective view of a metasurface according to yet another embodiment.

FIG. 22 is a schematic view of a metasurface according to yet another embodiment.

FIG. 23 is a schematic view of a metasurface according to yet another embodiment.

FIG. 24 is a schematic view of a metasurface according to yet another embodiment.

FIG. 25 is a cross-sectional view of a light source unit, a first lens, a second lens, a first mirror, a second mirror, and a third lens in a projecting device according to still another embodiment.

FIG. 26 is an exploded perspective view illustrating a first mirror, a second mirror, and a metasurface in the projecting device according to still another embodiment.

### MODES OF THE INVENTION

Hereinafter, exemplary embodiments of the present invention will be described in detail with reference to the attached drawings.

However, the technical idea of the present invention is not limited to some embodiments to be described, but can be implemented in various different forms, and within the scope of the technical idea of the present invention, one or more of the components among the embodiments can be selectively combined or substituted and used.

In addition, terms (including technical and scientific terms) used in the embodiments of the present invention can be interpreted as having a meaning that can be generally understood by a person of ordinary skill in the technical field to which the present invention belongs, unless explicitly and specifically defined and described, and terms that are commonly used, such as terms defined in a dictionary, can be interpreted in consideration of the contextual meaning of the relevant technology.

Additionally, the terms used in the embodiments of the present invention are for the purpose of describing the embodiments and are not intended to limit the present invention.

In this specification, the singular may also include the plural unless specifically stated otherwise in the phrase, and when it is described as “at least one (or one or more) of A, B, and C,” it may include one or more of all combinations in which A, B, and C can be combined.

Additionally, in describing components of embodiments of the present invention, terms such as first, second, A, B, (a), (b), and the like may be used.

These terms are only intended to distinguish one component from another, and the nature, order, sequence, and the like of the component are not limited by these terms.

Further, when a certain component is described as being ‘connected,’ ‘coupled,’ or ‘joined’ to another component, it may include not only cases where the component is directly connected, coupled, or joined to the other component, but also cases where the component is ‘connected,’ ‘coupled,’ or ‘joined’ by still another component between the component and the other component.

Additionally, when one component is described as being formed or disposed “above (upper) or below (lower)” another component, above (upper) or below (lower) includes not only cases where the two components are in direct contact with each other, but also cases where one or more still other components are formed or disposed between the two components. Additionally, when expressed as “above (upper) or below (lower),” it may include the meaning of not only the upward direction but also the downward direction based on one component.

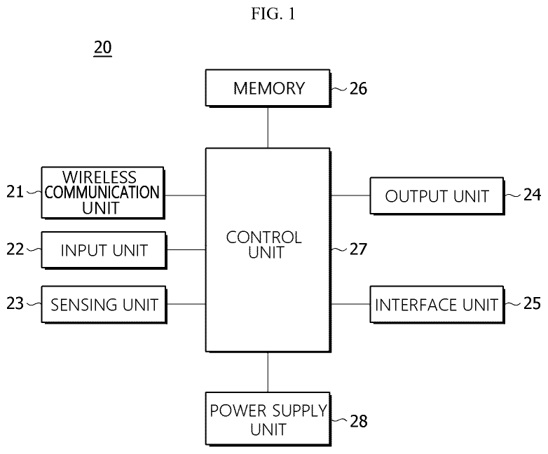

FIG. 1 is a block diagram showing the configuration of an extended reality electronic device according to an embodiment of the present invention.

Referring to FIG. 1, an extended reality electronic device 20 may include a wireless communication unit 21, an input unit 22, a sensing unit 23, an output unit 24, an interface unit 25, a memory 26, a control unit 27, a power supply unit 28, and the like. The components illustrated in FIG. 1 are not essential for implementing the electronic device 20, and thus the electronic device 20 described in this specification may have more or fewer components than the components listed above.

More specifically, among the above components, the wireless communication unit 21 may include one or more modules that enable wireless communication between the electronic device 20 and a wireless communication system, between the electronic device 20 and another electronic device, or between the electronic device 20 and an external server. Additionally, the wireless communication unit 21 may include one or more modules that connect the electronic device 20 to one or more networks.

The wireless communication unit 21 may include at least one of a broadcast reception module, a mobile communication module, a wireless Internet module, a short-range communication module, and a position information module.

The input unit 22 may include a camera or a video input unit for video signal input, a microphone or an audio input unit for audio signal input, and a user input unit (for example, a touch key, a push key (mechanical key), etc.) for receiving information from a user. Voice data or image data collected from the input unit 22 may be analyzed and processed with the user's control commands.

The sensing unit 23 may include one or more sensors for detecting at least one of information in the electronic device 20, information about the surrounding environment surrounding the electronic device 20, and user information.

For example, the sensing unit 23 may include at least one of a proximity sensor, an illumination sensor, a touch sensor, an acceleration sensor, a magnetic sensor, a G-sensor, a gyroscope sensor, a motion sensor, an RGB sensor, an infrared sensor (IR sensor), a finger scan sensor, an ultrasonic sensor, an optical sensor (for example, a photographing means), a microphone, a battery gauge, an environmental sensor (for example, a barometer, a hygrometer, a thermometer, a radiation detection sensor, a heat detection sensor, a gas detection sensor, etc.), and a chemical sensor (for example, an electronic nose, a healthcare sensor, a biometric recognition sensor, etc.). Meanwhile, the electronic device 20 disclosed in this specification may utilize information detected by at least two of these sensors in combination.

The output unit 24 may be for generating output related to vision, hearing, tactile sensations, or the like and may include at least one of a display unit, an audio output unit, a haptic module, and an optical output unit. The display unit may be implemented as a touch screen by forming a mutual layer structure with the touch sensor or by being integrated with the touch sensor. The touch screen may function as a user input means that provides an input interface between the augmented reality electronic device 20 and the user and at the same time may provide an output interface between the augmented reality electronic device 20 and the user.

The interface unit 25 functions as a passageway for various types of external devices connected to the electronic device 20. Through the interface unit 25, the electronic device 20 may receive virtual reality or augmented reality content supplied from an external device and perform mutual interaction by transmitting and receiving various input signals, detecting signals, and data.

For example, the interface unit 25 may include at least one of a wired/wireless headset port, an external charger port, a wired/wireless data port, a memory card port, a port for connecting a device provided with an identification module, an audio input/output (I/O) port, a video input/output (I/O) port, and an earphone port.

Additionally, the memory 26 may store data that supports various functions of the electronic device 20. The memory 26 may store a plurality of application programs (or applications) driven by the electronic device 20, data for the operation of the electronic device 20, and commands. At least some of these application programs may be downloaded from external servers through wireless communication. Additionally, at least some of these application programs may be present on the electronic device 20 from the time of shipment for basic functions of the electronic device 20 (for example, incoming and outgoing call functions, message receiving and outgoing functions).

In addition to the operations related to the application program, the control unit 27 may typically control the overall operation of the electronic device 20. The control unit 27 may process signals, data, information, and the like input or output through the above-described components.

In addition, the control unit 27 may control at least some of the components by driving an application program stored in the memory 26 to provide appropriate information to the user or process a function. Furthermore, the control unit 27 may operate at least two or more of the components included in the electronic device 20 in combination to drive the application program.

In addition, the control unit 27 may detect the movement of the electronic device 20 or the user by using a gyroscope sensor, a gravity sensor, a motion sensor, and the like included in the sensing unit 23. Alternatively, the control unit 27 may detect an object approaching the electronic device 20 or the user by using a proximity sensor, an illumination sensor, a magnetic sensor, an infrared sensor, an ultrasonic sensor, a light sensor, or the like included in the sensing unit 23. In addition, the control unit 27 may detect the user's movement through sensors provided in a controller that operates in conjunction with the electronic device 20.

Additionally, the control unit 27 may perform the operations (or functions) of the electronic device 20 using the application program stored in the memory 26.

The power supply unit 28 may receive external power or internal power under the control of the control unit 27 and supply power to each of the components included in the electronic device 20. The power supply unit 28 may include a battery, and a battery may be provided in a built-in or replaceable form.

At least some of the above components may cooperate with each other to implement the operation, control, or control method of the electronic device according to various embodiments described below. Additionally, the operation, control, or control method of the electronic device may be implemented on the electronic device by driving at least one application program stored in the memory 26.

Hereinafter, the electronic device described as one example of the present invention will be described based on an embodiment applied to a head mounted display (HMD). However, embodiments of the electronic device according to the present invention may include a mobile phone, a smart phone, a laptop computer, a digital broadcasting terminal, a personal digital assistant (PDA), a portable multimedia player (PMP), a navigation device, a slate PC, a tablet PC, an ultrabook, a wearable device, and the like. In addition to the HMD, the wearable device may include a watch-type terminal (smart watch), a contact lens, VR/AR/MR glasses, and the like.

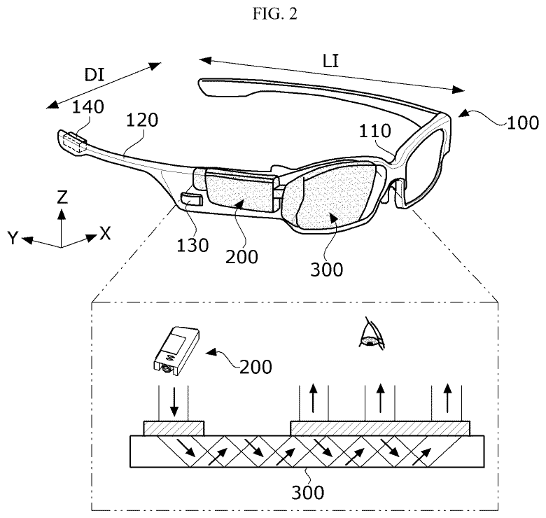

FIG. 2 is a perspective view of an augmented reality electronic device according to the embodiment of the present invention.

As illustrated in FIG. 2, the electronic device according to the embodiment of the present invention may include a frame 100, a projecting device 200, and a display unit 300.

The electronic device may be provided in the form of glasses (smart glasses). The glasses-type electronic device is configured to be worn on the head of the human body and may include the frame 100 (case, housing, etc.) for this purpose. The frame 100 may be formed of a flexible material for easy wearing.

The frame 100 may be supported on the head and may provide a space for mounting various parts. As illustrated in the drawings, electronic components, such as the projecting device 200, a user input unit 130, or an audio output unit 140, may be mounted on the frame 100. Additionally, a lens covering at least one of the left and right eyes may be detachably mounted on the frame 100.

The frame 100 may have a form of glasses worn on the face of the user's body as shown in the drawings, but is not necessarily limited thereto, and may also have a form such as goggles worn in close contact with the user's face.

The frame 100 may include a front frame 110 having at least one opening, and a pair of side frames 120 that extend in an y-direction (see FIG. 2) intersecting the front frame 110 and are parallel to each other.

The frame 100 may have a length DI in an x-direction and a length LI in the y-direction, which may be the same or different.

The projecting device 200 may be provided to control various electronic components provided in the electronic device. The projecting device 200 may be used interchangeably with an ‘optical output device,’ an ‘optical projecting device,’ a ‘light irradiation device,’ an ‘optical device,’ etc.

The projecting device 200 may generate an image or a video including a series of images that is displayed to the user. The projecting device 200 may include an image source panel that generates an image, a plurality of lenses that diffuse and converge light generated from the image source panel, and the like.

The projecting device 200 may be fixed to any one side frame 120 of the two side frames 120. For example, the projecting device 200 may be fixed to the inner side or outer side of any one side frame 120 or may be integrally formed by being built into any one side frame 120. Alternatively, the projecting device 200 may be fixed to the front frame 110 or provided separately from the electronic device.

The display unit 300 may be implemented in the form of a head mounted display (HMD). The HMD form is a display that is mounted on the head and shows an image directly in front of the user's eyes. When the user wears the electronic device, the display unit 300 may be disposed to correspond to at least one of the left and right eyes so that an image is directly provided in front of the user's eyes. The drawing illustrates the display unit 300 located in a portion corresponding to the user's right eye so that an image is output toward the right eye. However, as described above, the present invention is not limited thereto and the display unit 300 may be disposed on both the left and right eyes.

The display unit 300 may allow the user to visually perceive the external environment while simultaneously displaying an image generated by the projecting device 200 to the user. For example, the display unit 300 may project an image onto the display region using a prism.

Further, the display unit 300 may be formed to be transparent so that the projected image and the general field of view in front (the range that the user sees through his/her eyes) can be seen simultaneously. For example, the display unit 300 may be translucent and may be formed of an optical member including glass.

Further, the display unit 300 may be inserted into and fixed in an opening included in the front frame 110 or may be located on the back surface of the opening (that is, between the opening and the user) and fixed to the front frame 110. Although the drawing illustrates, as one example, a case in which the display unit 300 is located on the back surface of the opening and fixed to the front frame 110, the display unit 300 may be disposed and fixed at various locations on the frame 100.

As illustrated in FIG. 2, when the electronic device causes image light for an image from the projecting device 200 to be incident on one side of the display unit 300, the image light is emitted to the other side through the display unit 300, thereby allowing the user to see the image generated from the projecting device 200.

Accordingly, the user may see the external environment through the opening of the frame 100 and simultaneously see the image generated by the projecting device 200. That is, the image output through the display unit 300 may appear to overlap the general field of view. The electronic device may use these display characteristics to provide augmented reality (AR), which superimposes virtual images on real-world images or backgrounds to create a single image.

Furthermore, in addition to the above operation, images generated from the external environment and the projecting device 200 may be provided to the user with a time difference for a short period of time that is not recognized by the person. For example, in one frame, an external environment may be provided to a person in one section, and in another section, an image from the projecting device 200 may be provided to the person.

Alternatively, both the superimposition and the time difference may be provided.

In addition, the projecting device according to the embodiment may have a structure described below or may be formed of a structure further including a waveguide or/and glass in the structure. Additionally, the projecting device may include a digital light processing (DLP) projector or projecting device.

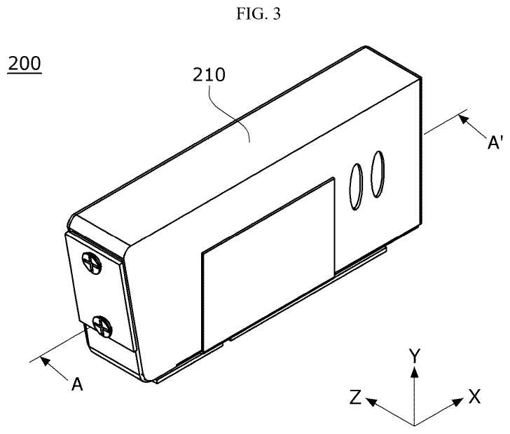

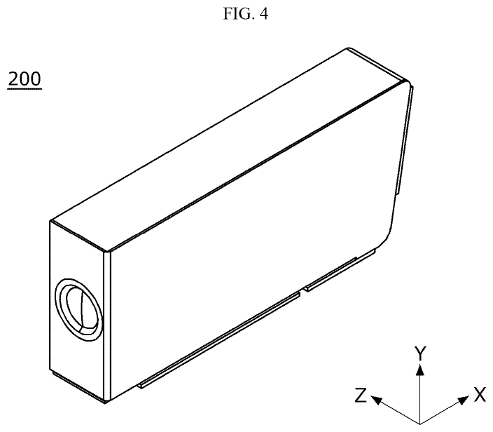

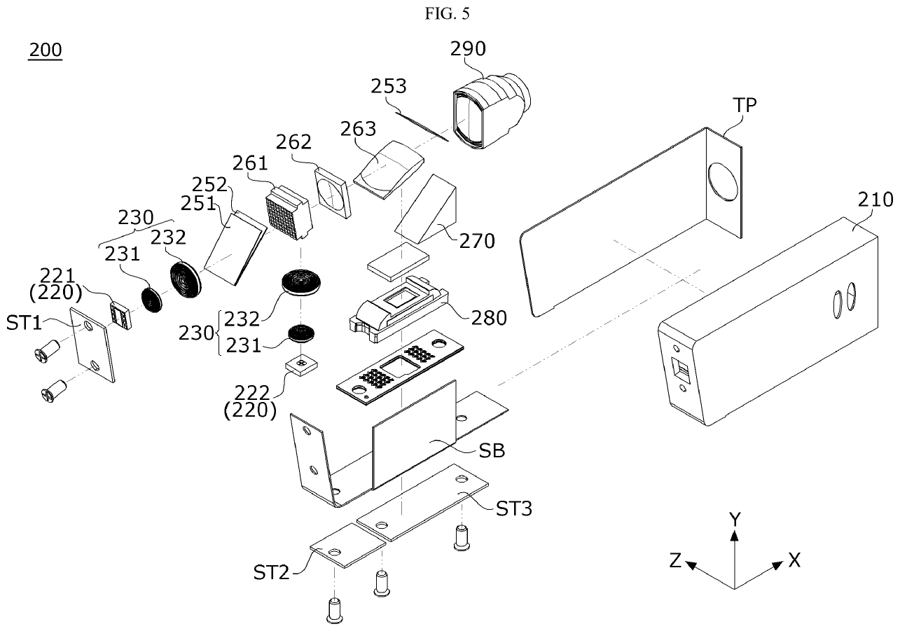

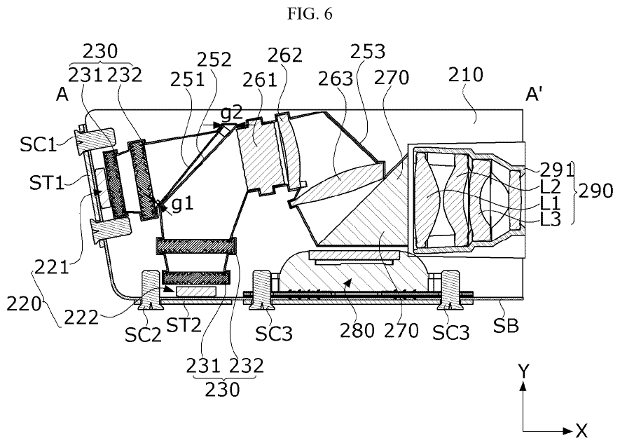

FIG. 3 is a perspective view of the projecting device according to the embodiment, FIG. 4 is another perspective view of the projecting device according to the embodiment, FIG. 5 is an exploded perspective view of the projecting device according to the embodiment, and FIG. 6 is a cross-sectional view along line AA′ in FIG. 3.

Referring to FIGS. 3 to 6, the projecting device 200 according to the embodiment may include a housing 210, a light source unit 220, a first lens 231, a second lens 232, a first mirror 251, a second mirror 252, a third lens 261, a fourth lens 262, a third mirror 253, a fifth lens 263, a prism 270, an optical modulator 280, a projection lens unit 290, and a blocking member TP.

The housing 210 may have a space or housing groove in which each component of the projecting device 200 is accommodated or disposed. The housing 210 may be located at an outer side of the projecting device 200. For example, the light source unit 220, the first lens 231, the second lens 232, the first mirror 251, the second mirror 252, the third lens 261, the fourth lens 262, the third mirror 253, the fifth lens 263, the prism 270, the optical modulator 280, and the projection lens unit 290 may be disposed in the housing 210.

Additionally, the housing 210 may have a structure in which one side is open. Accordingly, each of the above-described components may be assembled through the open region or surface. Furthermore, the blocking member TP described below may be disposed in the open region or surface of the housing 210.

The housing 210 may have various shapes. For example, the housing 210 may have a hexahedral structure. Accordingly, the projecting device according to the embodiment may be easily mounted in the electronic device. In addition, the projecting device according to the embodiment may be easily miniaturized or compactified.

The light source unit 220 may be disposed in the housing 210. The light source unit 220 may be disposed adjacent to any one of the outer surfaces of the housing 210.

The light source unit 220 may include at least one light source. In an embodiment, the light source unit 220 may include a first light source 221 and a second light source 222. The first light source 221 and the second light source 222 may be located adjacent to different surfaces in the housing 210. Furthermore, as described below, in an embodiment, the light source unit 220 may include only the first light source 221, the first light source 221 and the second light source 222, or the first light source 221 to a third light source.

Additionally, a plurality of light sources may emit light in different wavelength bands. As illustrated in the drawings, when the light source unit 220 is composed of the first light source 221 and the second light source 222, the first light source 221 and the second light source 222 may emit light in different wavelength bands or light of different colors. For example, the first light source 221 may emit light of a green wavelength. For example, the light of a green wavelength may be the center wavelength of the first light source 221. Further, the second light source 222 may emit red and blue light. For example, red and blue light may be the central wavelengths of the second light source 222.

Additionally, in the projecting device according to the embodiment, a first direction may correspond to an ‘X-axis direction’ in the drawings. The first direction may correspond to a direction from the first light source 221 toward the projection lens unit 290. Alternatively, the first direction may correspond to a direction from a first surface of the housing 210 toward a third surface. Furthermore, a second direction may correspond to a Y-axis direction in the drawings. The second direction may be a direction perpendicular to the first direction. A third direction may be a direction perpendicular to the first and second directions. Further, the third direction may correspond to a ‘Z-axis direction’ in the drawings.

Additionally, the first light source 221 and the second light source 222 in the light source unit 220 may emit light in parallel or different directions. In other words, a direction of light emission from the first light source 221 and a direction of light emission from the second light source 222 may not be parallel to each other.

A lens unit 230 may be located at a rear end of the light source unit 220. The lens unit 230 may include at least one lens. For example, the lens unit 230 may include the first lens 231 and the second lens 232.

Further, the first lens 231 and the second lens 232 may be disposed at the rear end of the light source unit 220. For example, the first lens 231 and the second lens 232 may be located at a rear end of each of the light sources of the light source unit 220. For example, the first lens 231 and the second lens 232 may be sequentially disposed at the rear end of the first light source 221. Additionally, the first lens 231 and the second lens 232 may be sequentially disposed at the rear end of the second light source 222. Hereinafter, a description will be made based on the first lens 231 and the second lens 232 located at the rear end of the first light source 221. Furthermore, the following description can be equally applied to the first lens 231 and the second lens 232 located at the rear end of the second light source 222 (or another light source).

Additionally, first lenses (or second lenses) adjacent to different light sources may be disposed to be spaced apart from each other in the second direction, and at least a part of which may be disposed to be offset in the first direction. For example, first lenses 231 that are spaced apart from each other may be disposed to be spaced apart from each other in the second direction (Y-axis direction). For example, at least a part of the first lenses 231 spaced apart from each other may be disposed to be offset in the first direction (X-axis direction). In other words, at least a part of the first lenses 231 spaced apart from each other may not overlap in the first direction (Y-axis direction).

The first lens 231 may be disposed closer to the first light source 221 than the second lens 232. That is, the first lens 231 may be located between the second lens 232 and the first light source 221.

The first lens 231 may be disposed so that light emitted from the first light source 221 is incident thereon. The first lens 231 may be disposed at the rear end of the first light source 221. In this embodiment, the rear end is described based on a direction in which light emitted from the light source travels. Further, light may be emitted from the light source and output to the outside through the projection lens unit 290. Accordingly, the projection lens unit 290 may be located at the rear end of the light source unit.

Further, light emitted from the first light source 221 may pass through the first lens 231. The first lens 231 may be located at a side of the first light source 221 in the first direction (X-axis direction). Alternatively, the first lens 231 may be located at a side of the first light source 221 in a light emission direction from the first light source 221.

Additionally, the first lens 231 may overlap the first light source 221 in the first direction (X-axis direction). Further, the second lens 232 may be disposed so that light passing through the first lens 231 is incident thereon. The second lens 232 may be located at a rear end of the first lens 231. Additionally, the second lens 232 may be located adjacent to the first lens 231. Light transmitted through the first lens 231 may transmit or pass through the second lens 232.

The second lens 232 may overlap the first light source 221 and the first lens 231 in the first direction (X-axis direction). Accordingly, the first lens 231 and the second lens 232 may collect light emitted from the first light source 221.

Further, the first light source 221, the first lens 231, and the second lens 232 may be sequentially disposed based on the direction in which light emitted from the first light source 221 travels.

At least one of the first lens 231 and the second lens 232 may be a Fresnel lens or a lens including a metasurface. For example, the first lens 231 and the second lens 232 may be formed as Fresnel lenses. Hereinafter, a description is made based on this. In addition, with this configuration, the loss of light emitted from the light source unit (for example, first light source) may be reduced, and the volume of the projecting device may be easily reduced. A detailed description of this will be made below.

The first mirror 251 and the second mirror 252 may be located at the rear end of the first lens 231 or the second lens 232. For example, the first mirror 251 and the second mirror 252 may be positioned on a side in the first direction (X-axis direction) from the first light source 221 or the first lens 231. Additionally, the first mirror 251 and the second mirror 252 may be disposed to be spaced apart from the first light source 221 or the first lens 231 in the first direction (X-axis direction). Further, light emitted from the first light source 221 (or the second light source) and light transmitted (or emitted) through the first lens 231 (or the second lens) may be transmitted through the first mirror 251 and the second mirror 252.

More specifically, light emitted from the first light source 221 and the first lens 231 may be transmitted through the first mirror 251. Further, the second mirror 252 may reflect light emitted from the second light source 222 and the second lens 232. Further, light passing through the first mirror 251 may be transmitted through the second mirror 252. With this configuration, light emitted from the first light source 221 and the second light source 222 may be collected by the first and second lens units and may then be incident on the third lens 261 at the rear end thereof. Accordingly, light required for optical modulation or image generation may be incident on the optical modulator 280.

Furthermore, the second mirror 252 may be disposed at a rear end of the first mirror 251. The first mirror 251 and the second mirror 252 may be tilted at a predetermined angle with respect to an X-axis or an Y-axis. Further, the first mirror 251 and the second mirror 252 may have different tilt angles with respect to the X-axis or the Y-axis.

Additionally, a separation distance between one ends of the first mirror 251 and the second mirror 252 may be different from a separation distance between the other ends thereof. For example, a separation distance g1 between one end of the first mirror 251 and one end of the second mirror 252 may be different from a separation distance g2 between the other end of the first mirror 251 and the other end of the second mirror 252. Further, the separation distance g1 between one end of the first mirror 251 and one end of the second mirror 252 may be smaller than the separation distance g2 between the other end of the first mirror 251 and the other end of the second mirror 252.

Additionally, the first mirror 251 and the second mirror 252 may have different lengths. For example, the first mirror 251 and the second mirror 252 may have different lengths on the XY plane. For example, a length of the second mirror disposed at the rear end may be greater than a length of the first mirror.

Additionally, the first mirror 251 and the second mirror 252 may include dichroic mirrors. The first mirror 251 may include a dichroic mirror for red. The second mirror 252 may include a dichroic mirror for blue.

Additionally, the first mirror 251 and the second mirror 252 may be implemented as prisms. For example, the first mirror 251 and the second mirror 252 may be implemented as an ‘X-cube.’ In this way, the first mirror 251 and the second mirror 252 may mean various mirror members for reflecting light incident in a plurality of directions to one exit surface or space.

The third lens 261 may be disposed at a rear end of the first mirror 251 and the second mirror 252. At least a part of the third lens 261 may overlap the first mirror 251 and the second mirror 252 in the first direction (X-axis direction). Furthermore, at least a part of the third lens 261 may overlap the first light source 221 and the first lens 231 in the first direction.

Light transmitted through the first mirror 251 and light reflected by the second mirror 252 may be transmitted through the third lens 261. For example, the third lens 261 may include a micro lens array (MLA) to diffuse the collected light. That is, the third lens 261 may be a diffuser or a diffusion unit. Additionally, the third lens 261 may include a fly-eye lens (FEL). For example, the third lens 261 may be formed of an array of small lenses. Accordingly, the third lens 261 may focus and condense light rays. In this way, the third lens 261 may focus light rays incident on the entire surface to a single point or a small region or may also diffuse the light rays. In an embodiment, the third lens 261 may collect light rays. Furthermore, the third lens 261 may reflect or refract light rays or separate light of a specific wavelength depending on the surface and shape of each of the lenses.

Additionally, the third lens 261 may be disposed between the second mirror 252 and the fourth lens 262. The second mirror 252 may be located at a front end of the third lens 261. Additionally, the fourth lens 262 may be disposed at a rear end of the third lens 261. In this way, in this specification, each component of the projecting device may be located between a component located at the front end and a component located at the rear end. For example, the third lens 261 may be located between at least one of the light source unit, the first and second lens units, the first mirror, and the second mirror, and at least one of the fourth lens, the third mirror, the fifth lens, the prism, the optical modulator, and the projection lens unit. Likewise, this positional relationship can be equally applied to other components.

The fourth lens 262 may be disposed at the rear end of the third lens 261. The fourth lens 262 may be disposed at a side of the third lens 261 in the first direction (X-axis direction). At least a part of the fourth lens 262 may overlap the third lens 261 in the first direction (X-axis direction). Similarly, at least a part of the fourth lens 262 may also overlap the first mirror 251, the second mirror 252, the first lens 231, and the first light source 221 in the first direction (X-axis direction). With this configuration, miniaturization of the projecting device can be easily achieved.

The fourth lens 262 may include a relay lens. Light emitted or transmitted through the third lens 261 may be transmitted through the fourth lens 262. The fourth lens 262 may transmit light rays from one location to another. In other words, the fourth lens 262 may arrange or change the path of the light rays. Furthermore, the fourth lens 262 may adjust a size of the light or image (maximum region of light rays) provided by an illuminating system or compensate for optical differences.

The third mirror 253 may be located at a rear end of the fourth lens 262. The third mirror 253 may be located at a side of the fourth lens 262 in the first direction (X-axis direction). The third mirror 253 may be disposed to be spaced apart from the fourth lens 262 in the first direction. The third mirror 253 may be called a ‘reflector.’

Further, the third mirror 253 may be tilted at a predetermined angle relative to the fourth lens 262. The third mirror 253 may reflect light emitted from the fourth lens 262. For example, light passing through the fourth lens 262 may be reflected by the third mirror 253, thereby causing a light path to be directed toward the projection lens unit and then reflected downward.

The third mirror 253 may be tilted at a predetermined angle with respect to the fourth lens 262, the first direction, or the like. With this configuration, the projecting device according to the embodiment may have its length minimized in the second direction.

The fifth lens 263 may be disposed at a rear end of the third mirror 253. The fifth lens 263 may be disposed below the third mirror 253. At least a part of the fifth lens 263 may overlap the third mirror 253 in the second direction.

The fifth lens 263 may include a relay lens. Light reflected from the third mirror 253 may be transmitted through the fifth lens 263. The fifth lens 263 may transmit light rays from one location to another. That is, the fifth lens 263 may arrange or change the path of the light rays. Furthermore, the fifth lens 263 may adjust the size of the light or image (maximum region of light) provided by the illuminating system or compensate for optical differences.

Additionally, the fourth lens 262, the third mirror 253, and the fifth lens 263 may be sequentially disposed so that light emitted or transmitted through the first mirror 251 and the second mirror 252 is incident.

Furthermore, an exit surface of the fifth lens 263 may be located above an exit surface of the first lens 231. Additionally, the exit surface of the fifth lens 263 may be located above an exit surface of the second lens 232.

The prism 270 may be disposed at a rear end of the fifth lens 263. Additionally, the prism 270 and the fifth lens 263 may be sequentially disposed. Furthermore, the prism 270 may be located below the fifth lens 263. The prism 270 and the fifth lens 263 may partially overlap in the second direction. Furthermore, some regions of the prism 270 may not overlap the fifth lens 263 in the second direction. With this configuration, light emitted (or transmitted) from the fifth lens 263 may be transmitted through the prism 270, and the transmitted light may be incident on the optical modulator 280 and reflected back to the projection lens unit 290.

The prism 270 may include a total internal reflection prism (TIR prism). The prism 270 may change the traveling direction of the light rays as described above. That is, the prism 270 may perform transmission and reflection of the light rays. Specifically, light emitted (or transmitted) from the fifth lens 263 may be transmitted through the prism 270 and light emitted from the optical modulator 280 may be reflected by the prism 270. Additionally, light emitted from the light source unit 220 may be transmitted through the prism 270 and the prism 270 may reflect light emitted from the optical modulator 280. Thus, the light path may be redirected to the first direction or projection lens unit. With this configuration, miniaturization of the projecting device according to the embodiment can be achieved.

The prism 270 may be disposed between the optical modulator 280 and the projection lens unit 290. Additionally, the prism 270 may be disposed between the fifth lens 263 and the optical modulator 280.

The optical modulator 280 may be disposed at a rear end of the prism 270. The optical modulator 280 may emit light transmitted through the prism 270 back to the prism 270.

The optical modulator 280 may project an image by reflecting incident light. For example, the optical modulator 280 may emit or project a video or image based on an image signal input through a board SB. That is, the optical modulator 280 may modulate the light emitted from the light source unit 220.

The optical modulator 280 according to the embodiment may include a digital micro mirror device (DMD). The optical modulator 280 may include a plurality of small mirrors. Further, each of the mirrors may reflect or block light depending on a signal (for example, a digital signal). In other words, the optical modulator 280 may control the state of each mirror based on the image signal applied through the board SB to project an image (or video) corresponding to the image signal. For example, when light is reflected by the control of a mirror, a bright image region may be output, and when light is blocked, a dark image region may be output.

Additionally, the second direction (Y-axis direction) may correspond to a vertical direction of an upper surface of the optical modulator 280.

The projection lens unit 290 may be disposed at the rear end of the prism 270. When light emitted from the optical modulator 280 is reflected by the prism 270, the light reflected by the prism 270 may be incident on the projection lens unit 290. The light described above may be projected from the projection lens unit 290. The projection lens unit 290 may project light emitted from the projecting device onto a screen or waveguide (or display unit).

In an embodiment, the projection lens unit 290 may adjust the size of the image so that light rays are incident in the effective aperture diameter (entrance pupil diameter, EPD) of the waveguide or the like.

To this end, the projection lens unit 290 according to the embodiment may include a lens barrel 291 and a plurality of lenses L1 to L4 (or optical systems) disposed in the lens barrel.

At least a part of the plurality of lenses L1 to L4 may overlap the prism 270 in the first direction.

The blocking member TP may be disposed on one outer surface of the housing 210. Accordingly, after each component is accommodated in the housing 210, the blocking member TP may be disposed on the outer side of each component. In an embodiment, the blocking member TP may be disposed on one side of the housing 210 to correspond to a groove of the housing 210. Further, the blocking member TP may cover each component. With this configuration, the blocking member TP may easily block foreign substances or external light from entering the components of the housing 210. Therefore, image projection of the electronic device or the projecting device may be implemented more accurately.

Additionally, the projecting device 200 according to the embodiment may include the board SB, fastening members SC1, SC2, and SC3, and reinforcement plates ST1, ST2, and ST3.

The board SB may be electrically connected to the light source unit 220 and the optical modulator 280. The light source unit 220 and the optical modulator 280 may be disposed on the board SB. Further, the board SB may be disposed on the housing 210. For example, the board SB may be disposed along the outer surface of the housing 210.

The operation of the optical modulator 280 and the light source unit 220 may be controlled through the board SB. The board SB may communicate with a control unit of an external device or the like in a wired or wireless manner. For example, external control signals may be transmitted to the projecting device through the board SB. Further, the projecting device may output an image based on the transmitted control signal.

The fastening members SC1, SC2, and SC3 may be disposed on the outer side of the board SB. Accordingly, the coupling strength between the board SB, the housing 210, the light source unit 220, and the optical modulator 280 can be improved. Furthermore, the board SB may be disposed on the outer side of the housing 210 to enhance the freedom of assembly or design.

The reinforcement plates ST1, ST2, and ST3 may be disposed on the outer side of the board SB. Furthermore, the reinforcement plates ST1, ST2, and ST3 may be made of various materials such as a metal, a composite material, and a resin (plastic) as stiffeners. The reinforcement plates ST1, ST2, and ST3 may be disposed on the outer side of the board SB to improve the rigidity and strength of the board SB and the housing. For example, the reinforcement plates ST1, ST2, and ST3 may be placed on the board SB to correspond to the positions of the light source unit 220 and the optical modulator 280. With this configuration, deformation due to heat or the like generated by the light source unit 220 and the optical modulator 280 can be suppressed. In addition, the reinforcement plates ST1, ST2, and ST3 may protect the projecting device from external impacts or the like.

The fastening members SC1, SC2, and SC3 may pass through the reinforcement plates ST1, ST2, and ST3.

For example, the fastening members may include a first fastening member SC1, a second fastening member SC2, and a third fastening member SC3. The reinforcement plates may include a first reinforcement plate ST1, a second reinforcement plate ST2, and a third reinforcement plate ST3.

The first fastening member SC1 and the first reinforcement plate ST1 may be located to correspond to the first light source 221. The first fastening member SC1 and the first reinforcement plate ST1 may overlap the first light source 221 in the first direction.

The second fastening member SC2 and the second reinforcement plate ST2 may be located to correspond to the second light source 222. The second fastening member SC2 and the second reinforcement plate ST2 may overlap the second light source 222 in the second direction.

The third fastening member SC3 and the third reinforcement plate ST3 may be located to correspond to the optical modulator 280. The third fastening member SC3 and the third reinforcement plate ST3 may overlap the optical modulator 280 in the second direction (Y-axis direction).

Further, each of the fastening members may pass through each of the reinforcement plates to improve the coupling strength between the board and the housing 210. Furthermore, the third fastening member SC3 may pass through the optical modulator 280 to improve the coupling strength between the optical modulator 280, the housing 210, and the board SB.

As a modified example, the reinforcement plate may be formed integrally rather than a plurality of reinforcement plates to correspond to the board SB. That is, the reinforcement plate may have a structure extending from the first light source 221 to the optical modulator 280.

Additionally, each of the boards may also be disposed to correspond to each light source and optical modulator. Additionally, the fastening members may also be disposed on each of the plurality of boards. Alternatively, each of the fasteners may pass through all of the plurality of boards. Accordingly, the plurality of boards may be coupled together using a single fastening member. Accordingly, the number of fastening members may be set to various odd or even numbers.

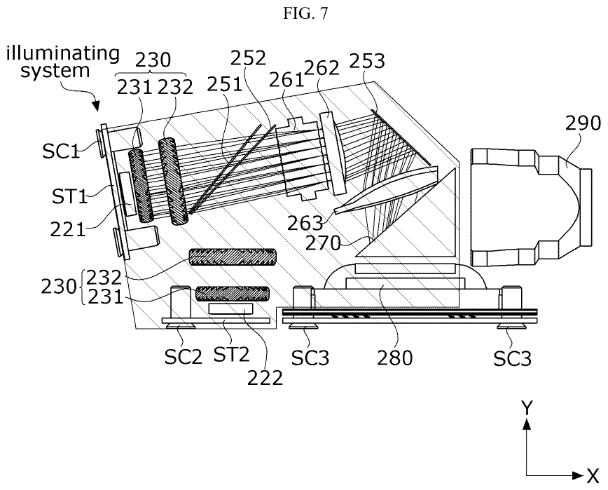

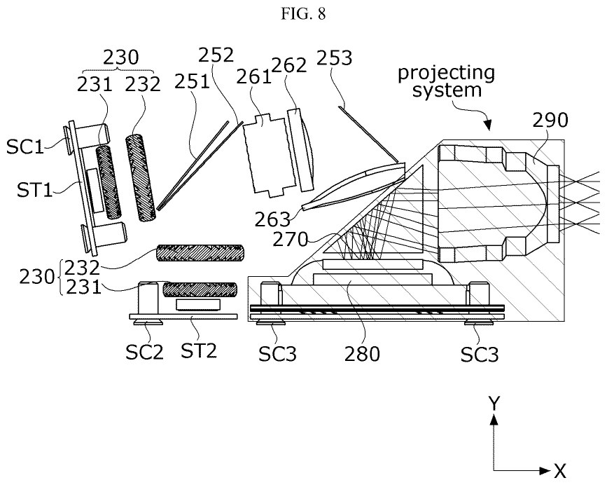

FIGS. 7 and 8 are views of the projecting device according to the embodiment from which the housing is removed.

The projecting device according to the embodiment may include an illuminating system and a projecting system (or a projection system, a projecting unit, a projecting part, a projection part, etc.).

Referring to FIG. 7, the projecting device may include an illuminating system. According to the embodiment, the illuminating system may include the housing 210, the light source unit 220, the first lens 231, the second lens 232, the first mirror 251, the second mirror 252, the third lens 261, the fourth lens 262, the third mirror 253, the fifth lens 263, and the prism 270. That is, light emitted from the prism 270 may be incident on the optical modulator 280.

This illuminating system may include the prism 270 as a component and receive light from the light source (illumination light) and emit light in a predetermined direction. The illumination light may be transmitted or provided to the optical modulator 280 of the projecting system.

Referring further to FIG. 8, the projecting system may include the prism 270, the optical modulator 280, and the projection lens unit 290. The projecting system may include the prism 270 as a component. In an embodiment, the prism 270 may be an element of both the illuminating system and the projecting system. That is, the projecting system may include components of the illuminating system described above.

Further, the projecting system may modulate the illumination light generated from the illuminating system through the optical modulator 280 and emit or diverge the light in a predetermined direction through the prism 270 and the projection lens unit 290.

In the projecting system, the optical modulator 280 may reflect the illumination light into patterned light or the like, and the patterned light may pass through the projection lens unit 290 and be output to the outside of the projecting device.

Additionally, the projecting device may include alight source unit, an illuminating system, an optical modulator, and a projecting system. Accordingly, the illuminating system may include the first lens 231, the second lens 232, the first mirror 251, the second mirror 252, the third lens 261, the fourth lens 262, the third mirror 253, the fifth lens 263, and the prism 270. Further, the projecting system may include the prism 270 and the projection lens unit 290.

Additionally, an optical folding member may be present between an output unit of the projecting device and an input unit of the waveguide. The optical folding member may be formed to fold the optical path of the patterned light in at least two different directions.

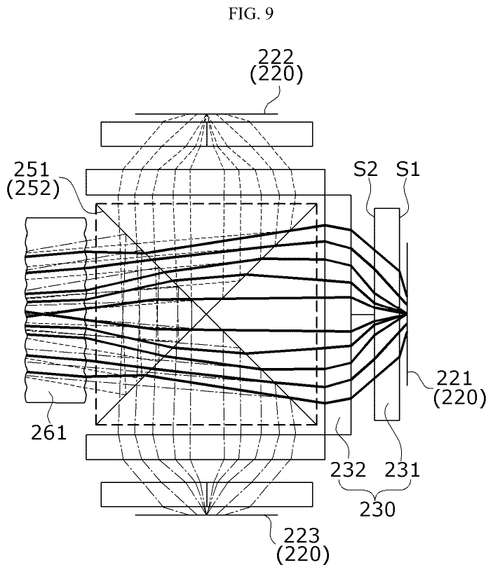

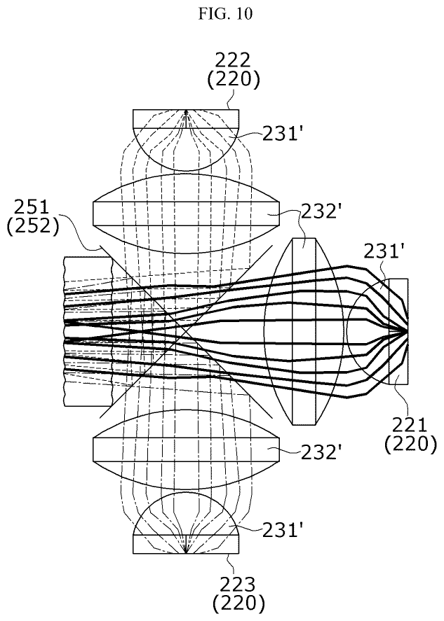

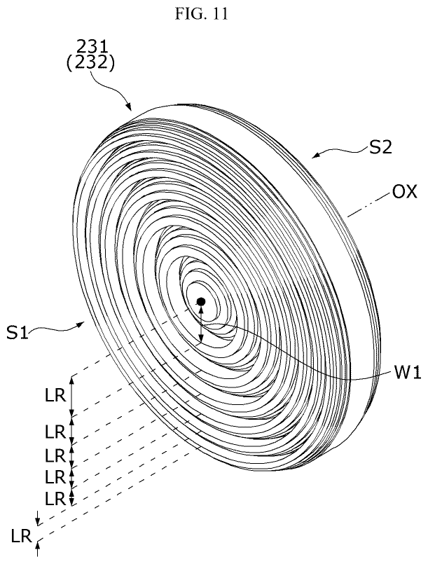

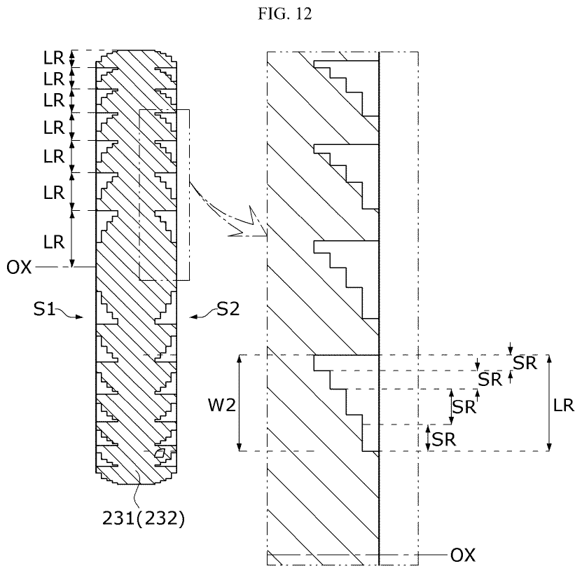

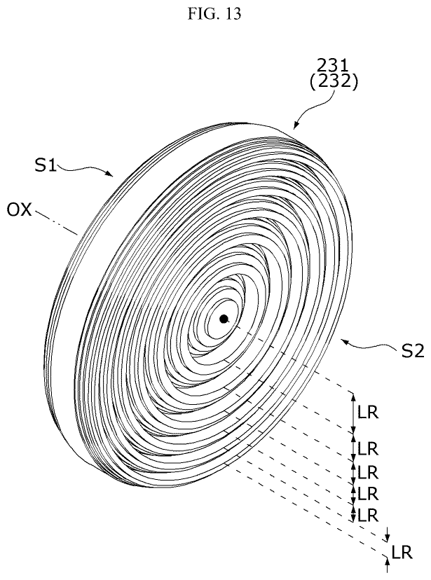

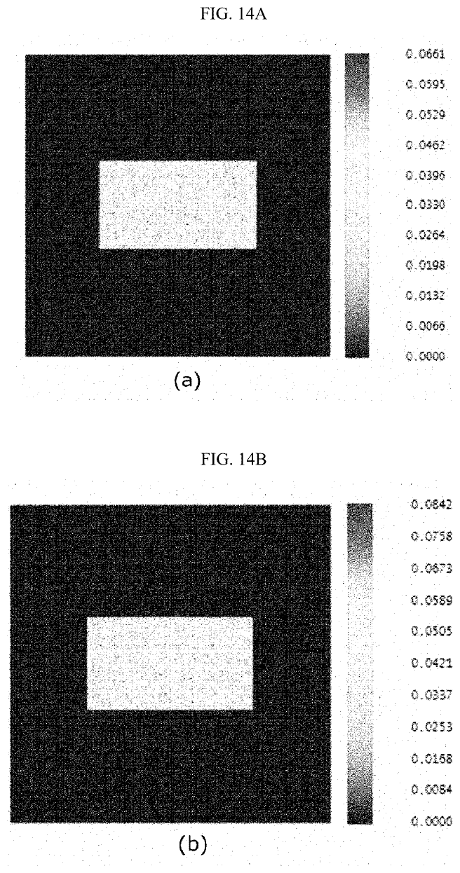

FIG. 9 is a cross-sectional view of the light source unit, the first lens, the second lens, the first mirror, the second mirror, and the third lens in the projecting device according to the embodiment, FIG. 10 is a cross-sectional view of the light source unit, the first lens, the second lens, the first mirror, the second mirror, and the third lens in a projecting device according to a comparative example, FIG. 11 is a perspective view of the first lens or the second lens in the projecting device according to the embodiment, FIG. 12 is a cross-sectional view of the first lens or the second lens in the projecting device according to the embodiment, and FIG. 13 is another perspective view of the first lens or the second lens in the projecting device according to the embodiment.

Referring to FIGS. 9 and 10, the projecting device according to the embodiment may include a light source module, and the light source module may include the light source unit 220, the first lens 231, the second lens 232, the first mirror 251, the second mirror 252, and the third lens 261.

Furthermore, the projecting device according to a comparative example also includes the light source module corresponding to the projecting device according to the embodiment, but in the case of the comparative example, a first lens 213′ and a second lens 232 of the light source module may be different from the first lens and the second lens according to the embodiment.

As described above, in the light source module of the projecting device according to the embodiment, at least one of the plurality of light sources, that is, the first lens 231 and the second lens 232, may include a Fresnel lens. For example, the first lens 231 and the second lens 232 may be formed as Fresnel lenses. With this configuration, a bundle of light may be easily collected in one place, and a separation distance between lenses may be reduced, thereby miniaturizing the projecting device.

Further, in the light source module of the projecting device according to the comparative example, the first lens 231′ and the second lens 232′ may be formed as refractive lenses.

First, referring to FIGS. 11 to 13, in the projecting device according to the embodiment, at least one of the first lens 231 and the second lens 232 may be a Fresnel lens. Although the following description is based on the first lens 231, the contents described below can also be applied to the second lens 232.

The first lens 231 may include a plurality of lens regions LR. Additionally, the plurality of lens regions LR may be partitioned or defined in the first lens 231. The plurality of lens regions LR may mean or correspond to a unit region of a pattern formed or arranged on a light source unit-side surface S1 or a reflector-side surface S2 of the first lens 231.

First, the first lens 231 may have a center. The center of the first lens 231 may correspond to an optical axis OX, a center of gravity, etc. In this embodiment, the center of the first lens 2231 may correspond to the optical axis OX.

A width W1 of each of the plurality of lens regions LR in the first lens 231 (or second lens) may differ in a direction away from the center. For example, the width of each of the plurality of lens regions LR in the first lens 231 may become smaller in a direction away from the center. Further, among the plurality of lens regions LR, the width of the lens region LR that overlaps the center or optical axis OX of the first lens 231 may be greatest. Additionally, the width of the lens region may increase toward the center of the first lens 231, among the plurality of lens regions LR.

Additionally, the maximum thicknesses of the plurality of lens regions LR may be the same. Accordingly, the maximum thickness in the lens region LR may be the same as the maximum thickness of an adjacent lens region.

Further, each of the plurality of lens regions LR according to the embodiment may include a plurality of sub-regions SR. That is, each of the lens regions LR may be composed of a plurality of sub-regions SR.

The plurality of sub-regions SR may be disposed adjacent to each other in the lens region LR. Further, in one lens region LR, the plurality of sub-regions SR may become smaller as they get further from the center of the first lens 231. That is, a width W2 of each of the sub-regions SR may become smaller the farther away from the center OX of the first lens 231.

Additionally, the widths of sub-regions SR having the same thickness in adjacent lens regions LR may be different from each other. Furthermore, the width of sub-regions having the same thickness and spaced apart from each other in adjacent lens regions LR may become smaller the farther away from the center OX of the first lens 231.

Additionally, in the drawings, the number of sub-regions SR in each of the lens regions LR may be the same or different. That is, the number of plurality of sub-regions SR is not limited to the number shown in the drawings.

Additionally, in the first lens 231, the lens region LR on the light source unit-side surface S1 and the lens region LR on the reflector-side surface S2 may be located opposite to each other in the optical axis direction. For example, the lens region LR on the light source unit-side surface S1 and the lens region LR on the reflector-side surface S2 may be formed symmetrically based on a surface that bisects the first lens 231 in the optical axis direction. With this configuration, the ease of manufacturing can be improved and structural reliability can be improved.

Additionally, the light source unit-side surface S1 and the reflector-side surface S2 of the first lens 231 may have different curvature radii and optical performance levels. Accordingly, the lens region LR on the light source unit-side surface S1 and the lens region LR on the reflector-side surface S2 of the first lens 231 may partially overlap in the optical axis direction. Further, in the first lens 231, at least a part of the lens region LR on the light source unit-side surface S1 may not overlap the lens region LR on the reflector-side surface S2 in the optical axis direction. For example, in the first lens 231, an n^{th} adjacent pattern (lens region) from a center OX of the light source unit-side surface S1 and an n^{th} adjacent pattern (lens region) from a center OX of the reflector-side surface S2 may not correspond in the optical axis direction. Further, in the first lens 231, at least a part of the n^{th} adjacent pattern (lens region) from the center OX of the light source unit-side surface S1 may not overlap the n^{th} adjacent pattern (lens region) from the center OX of the reflector-side surface S2 in the optical axis direction. With this configuration, performance, miniaturization, and the like can be easily implemented.

Furthermore, the maximum thickness of each of the plurality of lens regions LR in the first lens 231 may also be different.

A volume (cubic centimeter, cc) of the light source module in the projecting device may range from 1 cc to 7 cc. For example, the volume of the light source module may also change depending on changes in size or the like of the optical modulator.

Furthermore, referring to Table 1 or the like described below, a size of the light source module of the comparative example is 4.91 cc (24 mm×10 mm×19.5 mm). A size of the light source module of the embodiment is 3.03 cc (17 mm×10.5 mm×17 mm). In this way, the projecting device according to the embodiment may provide, as an effect, easy miniaturization through the first lens and the second lens described above.

The projecting device according to the embodiment may be designed and manufactured more compactly through the miniaturization of the light source module by using the first lens 231 (or second lens) described above. Therefore, the projecting device may be easily applied to wearable devices such as VR/AR/MR glasses, and may also resolve user inconvenience due to weight or the like.

More specifically, Table 1 is a table showing the size characteristics of the light source modules and the size of the optical modulator of the example and comparative example corresponding to FIGS. 9 and 10.

TABLE 1

| Diagonal | | | | | | | |
|---|---|---|---|---|---|---|---|
| size of | | Thickness | Thickness | | | | |
| optical | | of third | of first | Xcube | | | |
| modulator | DMD size | lens (MLA) | and second | (Z-axis | Z | X | Y |
| (DMD) [inch] | ratio | (mm) | lenses | thickness) | [mm] | [mm] | [mm] |
| 0.23 | 1 | 3.00 | 7.00 | 10.00 | 20.00 | 24.00 | 10.00 |
| 0.2 | 0.87 | 3.00 | 6.09 | 8.70 | 17.78 | 20.87 | 8.70 |
| 0.16 | 0.70 | 3.00 | 4.87 | 6.96 | 14.83 | 16.70 | 6.96 |
| 0.3 | 1.30 | 3.00 | 9.13 | 13.04 | 25.17 | 31.30 | 13.04 |

| Comparative Example | | | | | | | |
|---|---|---|---|---|---|---|---|
| | Thickness | Thickness | | | | | |
| | of third | of first | Xcube | Example | | | |
| Volume | lens (MLA) | and second | (Z-axis | Z | X | Y | Volume |
| [CC] | (mm) | lenses | thickness) | [mm] | [mm] | [mm] | [CC] |
| 4.80 | 3.00 | 4.00 | 10.00 | 17.00 | 18.00 | 10.00 | 3.06 |
| 3.23 | 3.00 | 3.48 | 8.70 | 15.17 | 15.65 | 8.70 | 2.07 |
| 1.72 | 3.00 | 2.78 | 6.96 | 12.74 | 12.52 | 6.96 | 1.11 |
| 10.28 | 3.00 | 5.22 | 13.04 | 21.26 | 23.48 | 13.04 | 6.51 |

Here, a thickness of the first lens and the second lens correspond to a length in the optical axis direction, and an X-cube also corresponds to a thickness in the optical axis direction. Further, the X-cube corresponds to the concept including the first and second mirrors described above. Further, here, the ‘third lens (MLLA)’ means both the case where the third lens is a micro lens array (MLA) and the case where a micro lens array is added to a rear end of the X-cube in addition to the third lens. Referring to Table 1, the size of the optical modulator and the volume of the light source module according to the embodiment may have a ratio of 1:5 to 1:25. Here, the unit for the size of the optical modulator is ‘inch,’ and the unit for the volume is ‘cc.’ When the above ratio is greater than 1:25, there is a limitation of difficulty in implementing miniaturization, and when the above ratio is less than 1:5, there is a limitation of difficulty in manufacturing design. Table 2 below is a table showing the characteristics of the components of the light source module in the comparative example, and Table 3 is a table showing the characteristics of the components of the light source module in the embodiment. Further the thickness of the light source unit-side surface of each of the lenses indicates the thickness of the corresponding lens. Further, the thickness of the reflector-side surface of each of the lenses indicates a separation distance between the corresponding lens and the rear component. For example, referring to Table 3, a separation distance between the first lens and the second lens may be 1 mm. Furthermore, the thickness and length may be in units of mm.

TABLE 2

| | | Thickness | Conic | 4^{th} | 6^{th} | 8^{th} | |
|---|---|---|---|---|---|---|---|
| Target | RadiuS | (mm) | constant | order | order | order | Remarks |
| Light source | — | 0.323 | — | — | — | — | |
| unit (LED) | | | | | | | |
| Light source | 3.303 | 3.015 | — | — | — | — | Spherical |
| unit-side | | | | | | | Lens |
| surface S1 of | | | | | | | |
| first lens | | | | | | | |
| Reflector- | 2.862 | 0.15 | — | — | — | — | |
| side surface | | | | | | | |
| S2 of first | | | | | | | |
| lens | | | | | | | |
| Light source | −5.612 | 4.473 | −4.73E+00 | −6.51E−05 | 5.95E−06 | −1.10E−07 | Aspheric |
| unit-side | | | | | | | lenses |
| surface S1 of | | | | | | | |
| second lens | | | | | | | |
| Reflector- | 6.116 | 8 | −2.12E+00 | −1.03E−04 | −4.88E−07 | 3.25E−08 | |
| side surface | | | | | | | |
| S2 of second | | | | | | | |
| lens | | | | | | | |

TABLE 3

| | | Thickness | Conic | |
|---|---|---|---|---|
| Target | Radius | (mm) | constant | Remarks |
| Light source | | 0.323 | | |
| unit (LED) | | | | |
| Light source | 7.83E+00 | 1.000 | | Spherical |
| unit-side | | | | Lens |
| surface S1 of | | | | |
| first lens | | | | |
| Reflector-side | 4.14E+00 | 1.000 | | |
| surface S2 of | | | | |
| first lens | | | | |
| Light source | −1.31E−01 | 1.000 | −4.73E+00 | Aspheric |
| unit-side | | | | lenses |
| surface S1 of | | | | |
| second lens | | | | |
| Reflector-side | 3.99E+00 | 10.000 | −2.12E+00 | |
| surface S2 of | | | | |
| second lens | | | | |

Referring to Tables 1 and 2, the separation distance between the first lens and the second lens in the projecting device according to the embodiment may be similar to the thickness. For example, the separation distance (or gap) between the first lens and the second lens may be 0.8 to 1.2 times the thickness of at least one of the first lens and the second lens. With this configuration, the ease of manufacturing and miniaturization can be realized. In addition, the first lens and the second lens may have the same or similar thickness. In an embodiment, the thickness of the first lens may be 0.8 to 1.2 times that of the second lens. With this configuration, the ease of manufacturing the lens and the reduction in thickness according to the Fresnel lens can be more effectively implemented. Further, in an embodiment, the light source unit-side surface of the first lens among the first lens and the second lens may have the greatest radius of curvature. A radius of curvature of the reflector-side surface of the first lens may be larger than radii of curvature of the light source unit-side surface and the reflector-side surface of the second lens.

Further, the radius of curvature of the light source unit-side surface of the second lens and the radius of curvature of the reflector-side surface may have different signs. For example, the radius of curvature of the light source unit-side surface of the second lens may have a negative sign, and the radius of curvature of the reflector-side surface may have a positive sign. Accordingly, the light source unit-side surface of the second lens may be convex toward the reflector or concave toward the light source unit. Further, the reflector-side surface of the second lens may be convex toward the light source unit. In this case, the radius of curvature may be a radius of curvature of a portion corresponding to the optical axis on the light source unit-side surface (or reflector-side surface) of each of the first lens and the second lens.

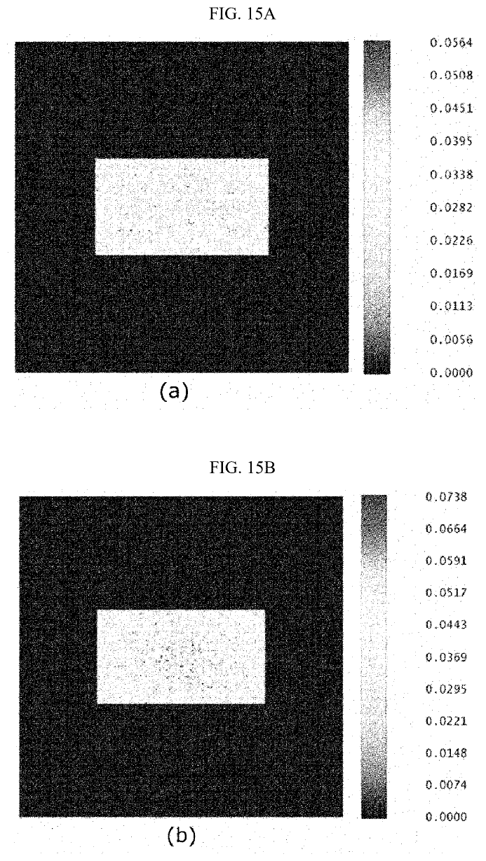

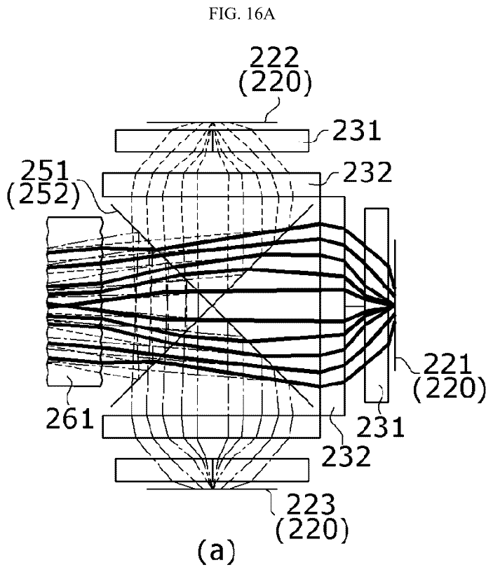

FIGS. 14 and 15 are views showing the optical performance of the projecting devices according to the comparative example and the embodiment.

FIGS. 14 and 15 are the results of geometric image analysis from the light source unit-side surface of the first lens. Particularly, in each of FIGS. 14A to 15B, an X-axis and a Y-axis of the left image represent an x or horizontal direction position and a y or vertical direction position, respectively. Also, a Z-axis corresponds to the optical axis. Furthermore, FIGS. 14 and 15 are analysis results where a field position is set to (0 [mm], 0 [mm]), an image size is set to 10 mm, and pixels are set to 255×255.

Referring to FIGS. 14A, 14B, 15A, and 15B, it can be seen that the optical performance of the light source module according to the embodiment is similar to the optical performance of the light source module according to the comparative example. Accordingly, the projecting device according to the embodiment may implement easy miniaturization while maintaining optical performance.

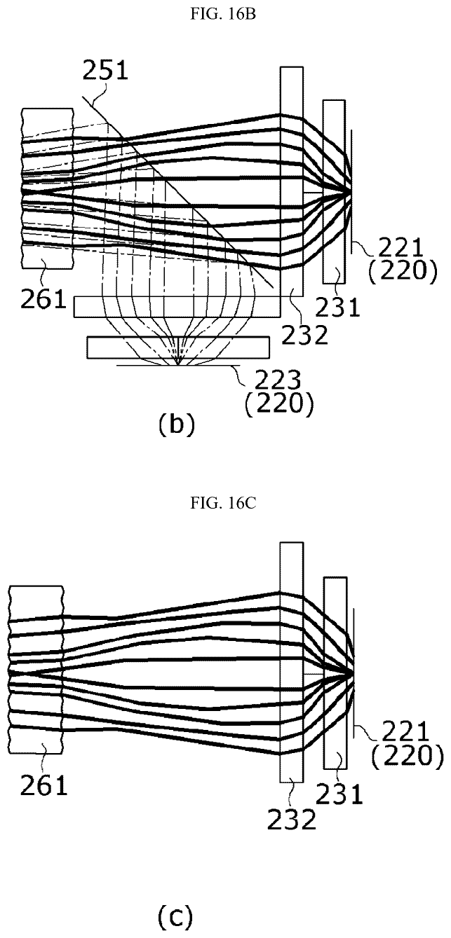

FIG. 16 is a configuration diagram of the light source unit-side according to various examples in the projecting device according to the embodiment.

As described above, the light source unit in the light source module of the projecting device may be composed of at least one light source.

As shown in FIG. 16A, the light source unit 220 in the projecting device may include three light sources. For example, the light source unit 220 may include a first light source 221, a second light source 222, and a third light source 223. Furthermore, both the first lens 231 and the second lens 232 may be disposed at a rear end of each of the light sources.

In the case of the comparative example, the first lens and the second lens in the light source module may be formed as refractive lenses. In this case, a volume of the light source module may be 4.8 cc (24 mm×10 mm×20 mm). Alternatively, in the case of the embodiment, a volume of the light source module may be 3.06 cc (18 mm×10 mm×17 mm).

Referring to FIG. 16B, the light source unit 220 may be composed of two light sources, and may include, for example, the first light source 221 and the second light source 222. Similarly, both the first lens 231 and the second lens 232 may be disposed at the rear end of each of the light sources.

In the case of the comparative example, the first lens and the second lens in the light source module may be formed as refractive lenses, and the volume of the light source module according to the comparative example may be 3.4 cc (17 mm×10 mm×20 mm). Alternatively, in the case of the embodiment, the volume of the light source module may be 2.38 cc (14 mm×10 mm×17 mm).

Referring to FIG. 16C, the light source unit 220 may be composed of one light source and may include, for example, the first light source 221. Similarly, the first lens 231 and the second lens 232 may be disposed at a rear end of the first light source.

In the case of the comparative example, the first lens and the second lens in the light source module may be formed as refractive lenses, and the volume of the light source module according to the comparative example may be 2 cc (10 mm×10 mm×20 mm). Alternatively, in the case of the embodiment, the volume of the light source module may be 1.7 cc (10 mm×10 mm×17 mm).

In this way, as described above, the volume of the light source module may be reduced according to the embodiment. Furthermore, the overall volume of the projecting device may also be reduced by reducing the number of light sources in the projecting device.

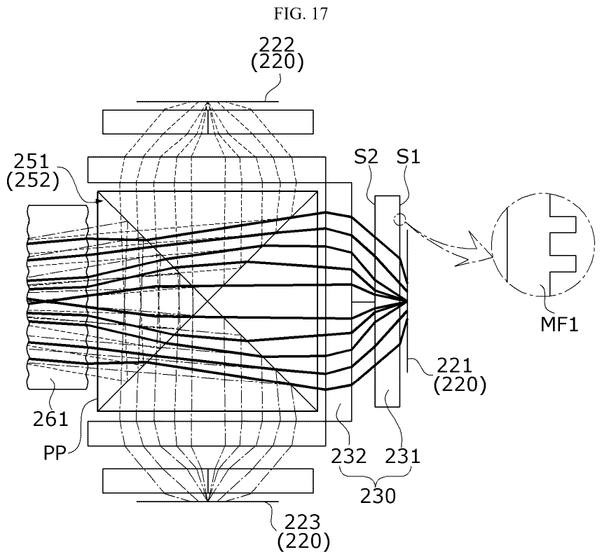

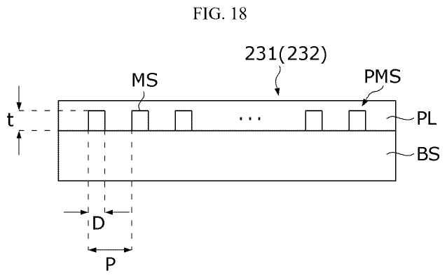

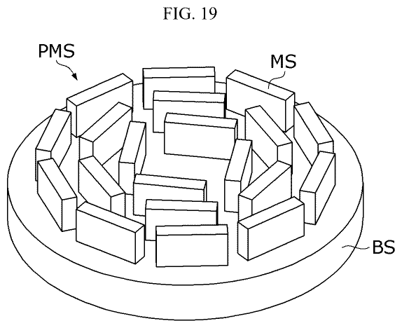

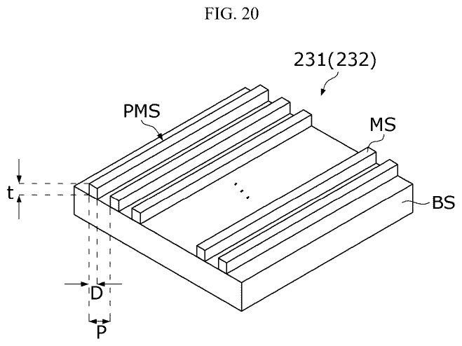

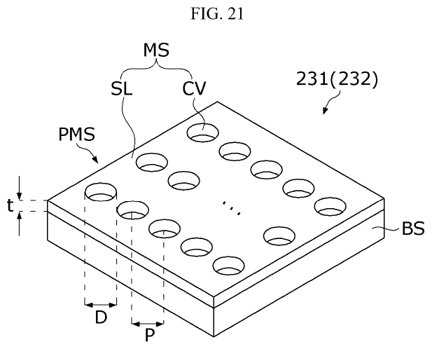

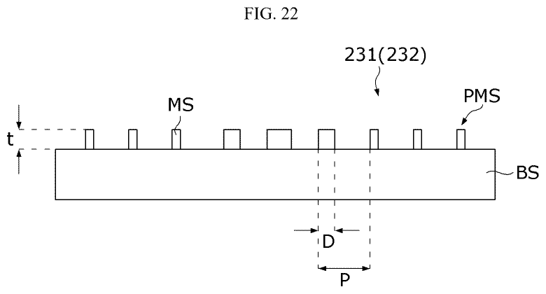

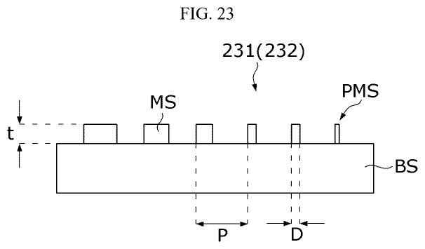

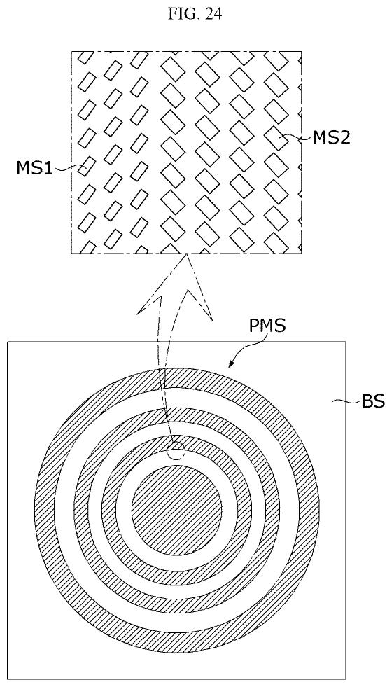

FIG. 17 is a cross-sectional view of a light source unit, a first lens, a second lens, a first mirror, a second mirror, and a third lens in a projecting device according to another embodiment, FIG. 18 is a schematic view of a metasurface applied to a rear end of the light source unit according to the embodiment, FIG. 19 is a schematic perspective view of a metasurface according to another embodiment, FIG. 20 is a schematic perspective view of a metasurface according to still another embodiment, FIG. 21 is a schematic perspective view of a metasurface according to yet another embodiment, FIG. 22 is a schematic view of a metasurface according to yet another embodiment, FIG. 23 is a schematic view of a metasurface according to yet another embodiment, and FIG. 24 is a schematic view of a metasurface according to yet another embodiment.

Referring to FIGS. 17 and 18, the projecting device according to another embodiment can be applied in the same manner as the above-described projecting device, etc. For example, the projecting device according to another embodiment may include a housing, a light source unit 220, a first lens 231, a second lens 232, a first mirror 251, a second mirror 252, a third lens 261, a fourth lens, a third mirror, a fifth lens, a prism, an optical modulator, a projection lens unit, and a blocking member. Furthermore, the projecting device may include other components as described above and include an illuminating system and a projecting system in terms of optical aspects. Further, it should be understood that other embodiments or the above-described contents may be applied, except for contents described below.

Furthermore, the projecting device described below may have a metasurface. The metasurface may be located at the rear end of the light source unit. For example, the metasurface may be located on the first lens, the second lens, or the front prism (the X-cube described above) at the rear end of the light source unit.

Specifically, in the projecting device according to the embodiment, at least one of the first lens 231 and the second lens 232 may have a first metasurface. By means of this first metasurface, the first lens and the second lens may be disposed in similar sizes and positions as in the case of the above-described Fresnel lens. That is, a volume and size of the light source module may be kept small.

The first metasurface may be located on at least one of a light source unit-side surface and a reflector-side surface of the first lens 231 and the second lens 232. Hereinafter, a description will be made based on the light source unit-side surface of the first lens 231.

A first metasurface MF1 may be arranged to form a shape distribution that changes the phase of incident light according to a predetermined rule depending on the position. Further, the first metasurface MF1 may include a plurality of structures MS having dimensions (for example, width D, thickness t, etc.) for a shape according to a sub-wavelength. Here, the sub-wavelength means a smaller wavelength than the incident light, and the incident light may be a target of phase modulation.

For example, in the first metasurface MF1, at least one of the dimensions of the shape, such as a width and a thickness, may correspond to a sub-wavelength. That is, the first metasurface MF may include a plurality of patterned structures MS having a smaller width or thickness than the wavelength of incident light.

Further, a distance between centers of adjacent structures MS may be expressed as a pitch P, and this pitch P may also be a sub-wavelength or correspond to a sub-wavelength.

The width D, the thickness t, and the pitch P of the plurality of structures MS may be arranged according to a predetermined rule determined by location. Further, the plurality of structures MS may be formed in an array form. For example, a structure array PMS in the form of an array of the plurality of structures may be determined according to a desired predetermined phase modulation pattern for light in a desired wavelength band. For example, the wavelength band may range from 300 nm to 1000 nm, from 400 nm to 750 nm, or from 700 nm to 1000 nm. This may be set in response to the color of the light described above.

Each of the plurality of structures MS may be formed on a base BS. The base BS may be made of a material having a refractive index lower than that of the structure MS. Further, a protective layer PL covering the plurality of structures MS may be further formed on the base BS. The protective layer PL may be formed of a material having a refractive index lower than that of the structure MS. The protective layer PL may be made of a material having the same refractive index as that of the base BS. The protective layer PL may be made of a light-transmitting material. Additionally, the protective layer PL may be omitted.

The structures MS may be made of a material having a refractive index higher than that of the base BS and may increase the modulation efficiency of modulating incident light. In other words, a range of phase modulation may be easily expanded by controlling the shape, distribution, arrangement, and the like of the structure array PMS. Further, this phase modulation may appear in the form of a transmission phase. Thus, when the loss is high (the absorption rate is high), that is, when the extinction coefficient k is large, the optical efficiency that can use the modulated light may become low. The structure MS according to the embodiment may widen the modulation range and increase the optical efficiency, thereby modulating light into various desired forms.

Referring to FIG. 19, the structure MS may have a polygonal columnar shape. However, the present invention is not limited thereto and the structure MS may have an elliptical column shape or various polygonal columnar shapes.

Further, the structure MS may be formed by arranging cylinders or polygonal columns of various diameters or widths at appropriate locations to form the structure array PMS. The structure array PMS composed of a plurality of structures may have a periodic arrangement, a quasi-periodic arrangement, a random arrangement, or a quasi-random arrangement.

Referring to FIG. 20, as an example, the first metasurface may include the structure array PMS in which stripe-shaped structures MS are arranged one-dimensionally. The width D of the stripe shape is shown to be constant, but may vary depending on the location.

Referring to FIG. 21, as another example, the structure MS in the first metasurface differs from the first metasurface described above in that it has an engraved cylindrical shape. That is, although the structure MS is implemented in an embossed form in the above-described embodiments, the structure may also be implemented in an engraved form, for example, a hole structure.

For example, the above-described structure MS may be formed on the base BS. Particularly, the structure MS may be composed of a plurality of engraved cavities CVs (or holes or grooves). Accordingly, the first metasurface may be formed in various shapes such as a slit, a groove, and a hole. The cavity CV is depicted as having a cylindrical shape, but is not limited thereto and may have an elliptical cylindrical shape, a polygonal cylindrical shape, or a stripe shape. It should also be understood that, in other embodiments, structures may be implemented in an embossed or engraved form.

Referring to FIG. 22, as still another example, the first metasurface may include a structure array PMS in which structures MS are arranged to function as convex lenses.

The structure array PMS may have an array form in which a width D of each of the structures MS gradually decreases from the center to the periphery.

Additionally, this array form may be a structure that is repeated at least once from the center of the base BS or the first metasurface toward the outer side or periphery. Further, a degree of convexity (positive refractive power) may be adjusted by controlling the trend of changing the width D, the number of patterns (or areas) that are repeated multiple times, etc.

Referring to FIG. 23, as yet another example, the first metasurface includes a structure array PMS in which structures MS are arranged to function as concave lenses.

The structure array PMS may have an arrangement form in which the width D of the structure MS gradually increases from the center to the periphery.

Additionally, this form may be a structure that is repeated at least once from the center of the base BS or the first metasurface toward the outer side or periphery. Further, a degree of concavity (negative refractive power) may be adjusted by controlling the trend of changing the width D, the number of patterns (or regions) that are repeated multiple times, etc.

Referring to FIG. 24, the structure array PMS may have a structure MS whose width D changes from the center to the periphery, and whose shape may also change. That is, the shapes of structures according to the various examples described above may be combined and implemented.

For example, the structure MS may include a first structure MS1 and a second structure MS2. The first structure MS1 and the second structure MS2 may have different shapes, and widths and thicknesses of which may be the same or different. Furthermore, arrangement directions or the like of the first structure MS1 and the second structure MS2 may also be different.

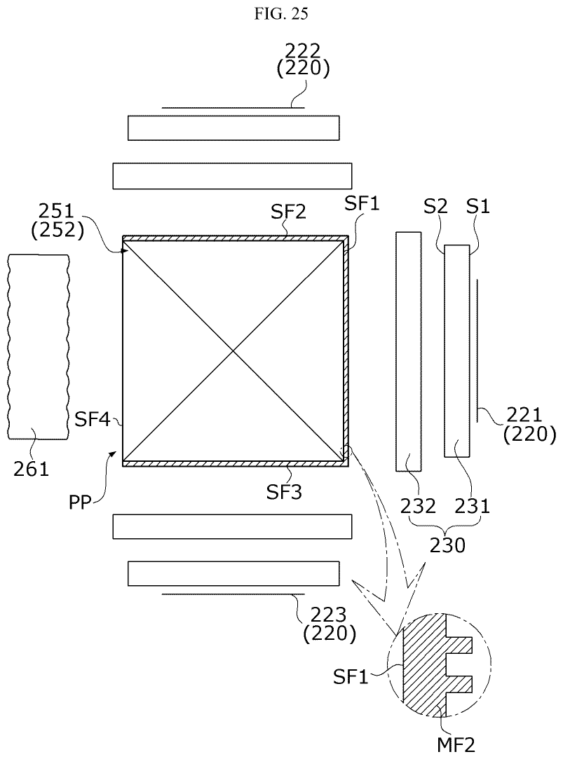

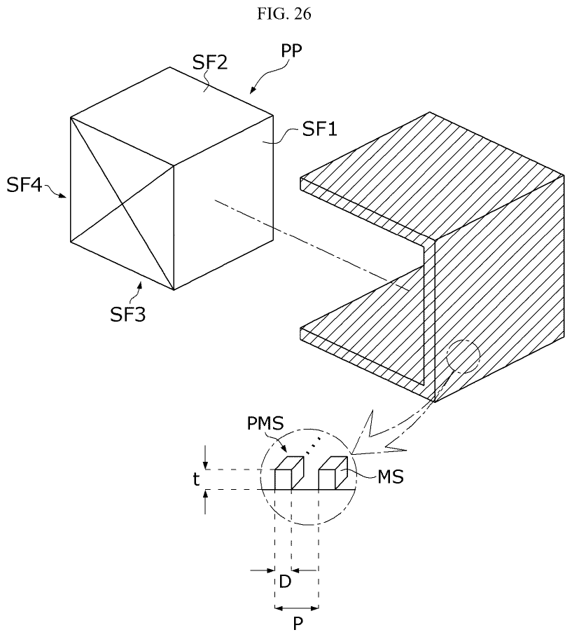

FIG. 25 is a cross-sectional view of a light source unit, a first lens, a second lens, a first mirror, a second mirror, and a third lens in a projecting device according to still another embodiment, and FIG. 26 is an exploded perspective view illustrating the first mirror, the second mirror, and a metasurface in the projecting device according to still another embodiment.

Referring to FIGS. 25 and 26, the projecting device according to still another embodiment may be applied in the same manner as the above-described projecting device or the like. For example, a projecting device according to still another embodiment may include a housing, a light source unit 220, a first lens 231, a second lens 232, a first mirror 251, a second mirror 252, a third lens 261, a fourth lens, a third mirror, a fifth lens, a prism, an optical modulator, a projection lens unit, and a blocking member. Furthermore, the projecting device may include other components as described above and may be composed of an illuminating system and a projecting system in terms of optical aspects. Further, it should be understood that other embodiments or the above-described contents may be applied, except for contents described below.

Furthermore, the projecting device described below may have a metasurface. The metasurface may be located at a rear end of the light source unit. For example, the metasurface may be located on the first lens, the second lens, or a front prism (the X-cube described above) at the rear end of the light source unit.

Particularly, in the present embodiment, the metasurface may be located between the light source unit and the reflector. Additionally, the metasurface may be located between the second lens and the reflector. Particularly, the metasurface may be located on the front prism to correspond to the first mirror and the second mirror. For example, the front prism may be formed of a prism, such as an x-cube,’ as described above.

A front prism PP may include an incident surface facing the light source unit (or each light source) and an exit surface through which light incident through the incident surface is reflected and then exits. Further, the front prism PP may include a second metasurface MF2 located on the incident surface. The second metasurface MF2 may be formed directly on an outer surface of the front prism. Alternatively, the metasurface MF2 may be formed by a wafer or the like, and the second metasurface MF2 may be disposed on the outer surface of the front prism through a bonding member or the like.

Specifically, the outer surface of the front prism PP may include a first outer surface SF1 to a third outer surface SF3 facing light sources 221, 222, and 223, respectively. The first outer surface SF1 may face the first light source 221. The second outer surface SF2 may face the second light source 222. The third outer surface SF3 may face the third light source 223. Alternatively, the first light source 221 may correspond to the first outer surface SF1. The second light source 222 may correspond to the second outer surface SF2. The third light source 223 may correspond to the third outer surface SF3.

Additionally, an outer surface of the front prism PP may include a fourth outer surface SF4. The fourth outer surface SF4 may be an outer surface facing a third lens MLA in the front prism PP. That is, the fourth outer surface SF4 may correspond to the third lens.

Further, the first outer surface SF1 and the fourth outer surface SF4 may be opposing surfaces of the front prism PP. For example, in the front prism PP, the first outer surface SF1 and the fourth outer surface SF4 may be located to correspond to each other. In the front prism PP, the first outer surface SF1 and the fourth outer surface SF4 may overlap in one direction. In the front prism PP, the first outer surface SF1 and the fourth outer surface SF4 may be surfaces facing each other.

The second outer surface SF2 and the third outer surface SF3 may be opposing surfaces of the front prism PP. For example, in the front prism PP, the second outer surface SF2 and the third outer surface SF3 may be located to correspond to each other. In the front prism PP, the second outer surface SF2 and the third outer surface SF3 can overlap in different directions. In the front prism PP, the second outer surface SF2 and the third outer surface SF3 may be surfaces facing each other.

Additionally, the outer surface may include a fifth outer surface and a sixth outer surface. The fifth outer surface and the sixth outer surface may be outer surfaces other than the first outer surface SF1 to the fourth outer surface SF4 among the outer surfaces of the front prism PP.

Furthermore, the projecting device may include the second metasurface MF2 located between the front prism PP and each of the light sources. Accordingly, the second metasurface MF2 may be in contact with the front prism PP.

The second metasurface MF2 may be located on each of the first to third outer surfaces or may be located integrally on the first to third outer surfaces. The second metasurface MF2 may have the same structure as the first metasurface described above.

That is, the second metasurface MF2 may be arranged to form a shape distribution that changes the phase of incident light according to a predetermined rule depending on the position. Further, the second metasurface MF2 may include a plurality of structures MS having dimensions (for example, width D, thickness t, etc.) for a shape according to a sub-wavelength. Here, the sub-wavelength means a smaller wavelength than the incident light, and the incident light may be a target of phase modulation.

For example, in the second metasurface MF2, at least one of the width and the thickness, which are the dimensions of the shape, may correspond to a sub-wavelength. That is, the second metasurface MF may include a plurality of patterned structures MS having a smaller width or thickness than the wavelength of incident light.

Further, a distance between centers of adjacent structures MS may be expressed as a pitch P, and this pitch P may also be a sub-wavelength or correspond to a sub-wavelength.

The width D, the thickness t, and the pitch P of the plurality of structures MS may be arranged according to a predetermined rule determined by location. Further, the plurality of structures MS may be formed in an array form. For example, a structure array PMS in the form of an array of multiple structures may be determined according to a desired predetermined phase modulation pattern for light in a desired wavelength band. The contents of the first metasurface described below may also be equally applied to the second metasurface.

Additionally, as a modified example, the metasurface may be located on the first lens, the second lens, or the front prism (the X-cube described above) at the rear end of the light source unit, and at least one of the first lens and the second lens may be formed as a Fresnel lens. For example, one of the first lens and the second lens may be formed as a Fresnel lens, and the other may include a metasurface. Additionally, as another example, the first lens and the second lens may be formed as Fresnel lenses, and the front prism may include a metasurface. That is, the metasurface may be formed on one of the first lens and the second lens and replaced with a Fresnel lens.

The features, structures, effects, and the like described in the embodiments above are included in at least one embodiment and are not necessarily limited to only one embodiment. Furthermore, the features, structures, effects, and the like exemplified in each of the embodiments may be combined or modified and implemented in other embodiments by a person having ordinary knowledge in the field to which the embodiments belong. Therefore, the contents related to these combinations and modifications should be interpreted as being included within the scope of the embodiments.

Although the description has been made focusing on examples above, these are merely examples and do not limit the present invention, and those with ordinary knowledge in the field to which the present invention belongs will recognize that various modifications and applications not exemplified above are possible without departing from the essential characteristics of these examples. For example, each component specifically shown in the examples may be modified and implemented. Further, the differences related to these modifications and applications should be interpreted as being included within the scope of the present invention defined in the appended claims.

1. A projecting device comprising:
a light source unit;
an optical modulator configured to modulate light emitted from the light source unit;
a prism disposed between the optical modulator and the light source unit;
a reflector disposed between the optical modulator and the prism;
a first lens disposed between the prism and the light source unit; and
a second lens disposed between the first lens and the prism,
wherein a distance between the first lens and the second lens is 0.8 to 1.2 times a thickness of at least one of the first lens and the second lens.

2. The projecting device of claim 1, wherein a ratio of a size of the optical modulator and a total volume of the light source unit, the first lens, and the second lens ranges from 1:5 to 1:25 (inch:cc).

3. The projecting device of claim 1, wherein at least one of the first lens and the second lens is a Fresnel lens.

4. The projecting device of claim 3, wherein the first lens and the second lens are Fresnel lenses,
each of the first lens and the second lens includes a plurality of lens regions, and
a width of each of the plurality of lens regions decreases in a direction away from a center of each of the first lens and the second lens.

5. The projecting device of claim 4, wherein each of the lens regions includes a plurality of sub-regions, and
a width of each of the sub-regions becomes smaller in the direction away from the center of each of the first lens and the second lens.

6. The projecting device of claim 5, wherein a plurality of sub-regions correspond to each other on each of a light source unit-side surface and a reflector-side surface of the first lens.

7. The projecting device of claim 1, wherein thicknesses of the first lens and the second lens are the same.

8. The projecting device of claim 1, wherein a separation distance between the first lens and the second lens is the same as a thickness of the first lens or the second lens.

9. The projecting device of claim 1, wherein, among the first lens and the second lens, a light source unit-side surface of the first lens has a greatest radius of curvature.

10. The projecting device of claim 1, wherein, in the second lens, a radius of curvature of a light source unit-side surface and a radius of curvature of a reflector-side surface have different signs.

11. The projecting device of claim 1, comprising a projection lens unit disposed at a rear end of the optical modulator.

12. The projecting device of claim 11, wherein light emitted from the light source unit is transmitted through the prism and light emitted from the optical modulator is reflected by the prism.

13. The projecting device of claim 11, wherein at least one of the first lens and the second lens has a first metasurface.

14. The projecting device of claim 13, wherein the first metasurface is located on at least one of a light source unit-side surface and a reflector-side surface of the first lens and the second lens.

15. The projecting device of claim 13, wherein the first metasurface is arranged to form a shape distribution that changes a phase of incident light according to a predetermined rule depending on the position.

16. The projecting device of claim 13, wherein the first metasurface includes a plurality of patterned structures having a smaller width or thickness than a wavelength of incident light.

17. The projecting device of claim 16, wherein the plurality of structures have a cylindrical shape, a polygonal columnar shape, or a stripe shape.

18. The projecting device of claim 13, comprising a front prism disposed between the reflector and the light source unit.

19. The projecting device of claim 18, wherein the front prism includes an incident surface facing the light source unit and an exit surface through which light incident through the incident surface is emitted.

20. The projecting device of claim 19, wherein the front prism includes a second metasurface located on the incident surface.
